(19) United States
(12) Patent Application Publication
(10) Pub. No.: US 2026/0023672 A1
(43) Pub. Date: Jan. 22, 2026

(54) DYNAMIC LOGGING

(71) Applicant: International Business Machines Corporation, Armonk, NY (US)

(72) Inventors: Sven Lange-Last, Leinfelden-Echterdingen (DE); Thomas Lumpp, Pliezhausen (DE); Martin Henke, Reutlingen (DE); Niels Korschinsky, Butzbach (DE); Michael Magrian, Leonberg (DE); Lukas Ziefle, Bondorf (DE); Marc Schwind, Altdorf (DE)

(73) Assignee: International Business Machines Corporation, Armonk, NY (US)

(21) Appl. No.: 18/779,345

(22) Filed: Jul. 22, 2024

(51) Int. Cl. G06F 11/34; G06F 11/07

(52) U.S. Cl. CPC G06F 11/3476; G06F 11/0781

(57) ABSTRACT

Methods, computer program products, and systems are presented. The method computer program products, and systems can include, for instance: generating log messages from one or more data source; evaluating one or more log message produced from the generating, and outputting, in dependence on the evaluating the one or more log message, a log message rating of the one or more log message; evaluating a logging system, and outputting, in dependence on the evaluating the logging system, a logging system rating of the logging system, wherein the logging system includes a logging volume for storing log messages; comparing the log message rating to the logging system rating; and producing an action decision impacting a count of log messages stored in the storage volume in dependence on the comparing of the log message rating, and the logging system rating.

### BACKGROUND

Embodiments herein relate generally to logging and particularly to dynamic logging.

Log messages for storing into a logging volume can include, e.g., application log messages, system log messages, security log messages, audit log messages, transaction log messages, and/or event log messages.

Data structures have been employed for improving operation of computer system. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: generating log messages from one or more data source; evaluating one or more log message produced from the generating, and outputting, in dependence on the evaluating the one or more log message, a log message rating of the one or more log message; evaluating a logging system, and outputting, in dependence on the evaluating the logging system, a logging system rating of the logging system, wherein the logging system includes a logging volume for storing log messages; comparing the log message rating to the logging system rating; and producing an action decision impacting a count of log messages stored in the storage volume in dependence on the comparing of the log message rating, and the logging system rating.

In another aspect, a computer program product can be provided. The computer program product can include a computer readable storage medium readable by one or more processing circuit and storing instructions for execution by one or more processor for performing a method. The method can include, for example: generating log messages from one or more data source; evaluating one or more log message produced from the generating, and outputting, in dependence on the evaluating the one or more log message, a log message rating of the one or more log message; evaluating a logging system, and outputting, in dependence on the evaluating the logging system, a logging system rating of the logging system, wherein the logging system includes a logging volume for storing log messages; comparing the log message rating to the logging system rating; and producing an action decision impacting a count of log messages stored in the storage volume in dependence on the comparing of the log message rating, and the logging system rating.

In a further aspect, a system can be provided. The system can include, for example, a memory. In addition, the system can include one or more processor in communication with the memory. Further, the system can include program instructions executable by the one or more processor via the memory to perform a method. The method can include, for example: generating log messages from one or more data source; evaluating one or more log message produced from the generating, and outputting, in dependence on the evaluating the one or more log message, a log message rating of the one or more log message; evaluating a logging system, and outputting, in dependence on the evaluating the logging system, a logging system rating of the logging system, wherein the logging system includes a logging volume for storing log messages; comparing the log message rating to the logging system rating; and producing an action decision impacting a count of log messages stored in the storage volume in dependence on the comparing of the log message rating, and the logging system rating.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a logging system having a logging manager and data sources according to one embodiment;

FIG. 2 is an infrastructure view depicting an illustrative computer environment defining a logging system as depicted in FIG. 1 according to one embodiment;

FIG. 3 is a flowchart illustrating a method for performance by a logging manager interoperating with data sources and a logging manager repository according to one embodiment;

FIG. 4 depicts a word2vec predictive model according to one embodiment;

FIG. 5A depicts a regression based predictive model for predicting a future log message rating in dependence on historical log message ratings, according to one embodiment;

FIG. 5B depicts a regression based predictive model for predicting a future logging system rating in dependence on historical log message ratings, according to one embodiment;

FIG. 6 is a flowchart illustrating a method for performance by a logging manager according to one embodiment;

FIG. 7 depicts a computing environment according to one embodiment.

### DETAILED DESCRIPTION

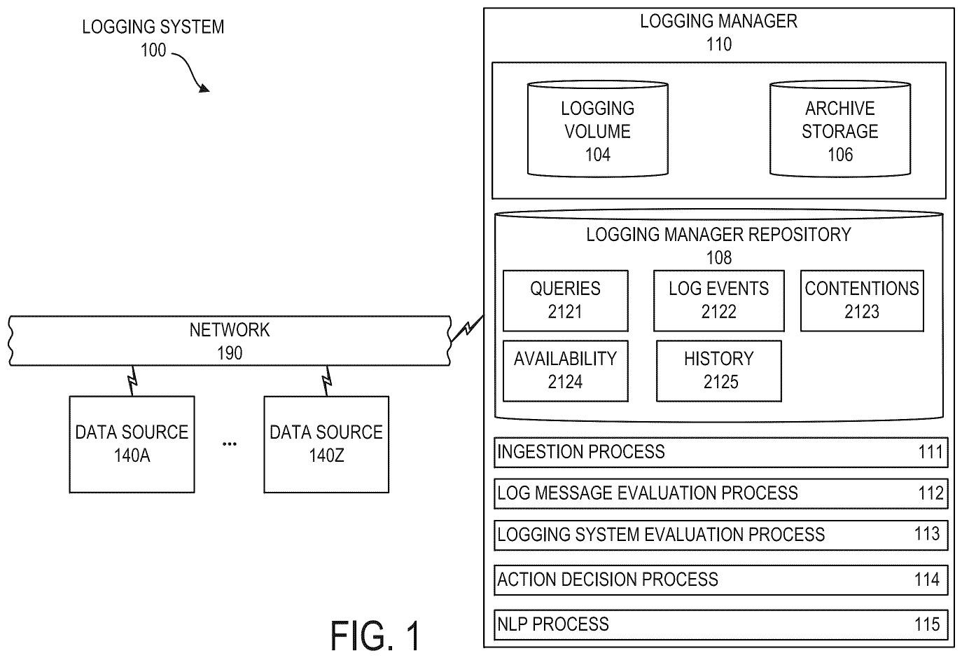

Logging system 100 for storing and managing log messages is shown in FIG. 1. Logging system 100 can include logging manager 110 having an associated logging manager repository 108 in communication with data sources 140A-140Z. Data sources 140A-140Z and logging manager 110 can be computing node-based systems in communication with one another via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

Data sources 140A-140Z can define sources of logging data defined by log messages. Data sources 140A-140Z can comprise e.g., logging agents of applications, which produce application log messages, logging agents of operating systems which include system log messages, logging agents which produce security log messages, logging agents which produce audit log messages, logging agents which produce transaction log messages, and logging agents which produce event log messages.

Logging manager 110 can manage logging volume 104 and archive storage 106. Logging volume 104, in one embodiment, can be configured as an indexed storage volume. An indexed storage volume herein can include a storage system designed for fast and efficient data retrieval, leveraging indexes to rapidly locate specific data points. The use of indexes can enhance performance, particularly for read-heavy workloads, and supports complex queries by reducing the need to scan entire datasets. A database index can include the use of keys to uniquely identify records. Indexes can be implemented using various structures such as hash tables or B-trees. In a further aspect, indexes can be created on one or more column to optimize queries. Full-text indexes can be used for searching within text fields, spatial indexes can be used for querying spatial data. In a further aspect, composite indexes can be created on multiple columns, and function-based indexes can be created using expressions or functions applied to columns. Archive storage 106, in one embodiment, can be configured as a cold storage volume. Cold storage refers to data storage solutions designed for infrequent access and long-term retention, optimized for cost efficiency. Archive storage 106 can be absent of any indexing functionality such that selecting of records from archive storage 106 can include scanning a complete volume of archive storage 106. Physical media options for archive storage 106 include, e.g., tape storage, discs, and hard drives, which can be configured to be powering down when not in use. In one embodiment, logging volume 104 and archive storage can be defined by differentiated physical media, e.g., logging volume 104 can be defined by one or more Solid-State Storage Device (SSD), and archive storage 106 can be defined by one or more hard drive.

Logging manager repository 108 can store various data for use in returning action decisions by logging manager 110. Logging manager repository 108 in queries area 2121 can store data specifying number of queries on logging volume 104 for respective log messages over a specified time. Embodiments herein recognize that queries on specific log messages stored in logging volume 104 can serve as an indicator of importance of the log entry.

Logging manager repository 108 in log events area 2122 can store metering data that specifies a count of log messages stored into logging volume 104 over a specified time period. Logging manager repository 108 in contentions area 2123 can store metering data specifying contentions recorded with respect to one or more computing node defining logging system 100. In one use case scenario, a logging contention can be observed when multiple processes try to read from or write to a storage device, such as a storage device defining logging volume 104. at the same time. Contentions can lead to longer wait times for I/O operations and reduce overall system throughput.

Logging manager repository 108 in availability area 2124 can store metering data on computing resources availability, e.g., of computing resources of one or more computing node defining logging volume 104 and or logging manager 110, which can be defined by software running on or more computing node 10. The software can include, e.g., one or more program. The one more program can be running in, e.g., one or more container based virtual machine deployed to the one or more computing node 10. Computing resource availability can specify, e.g., the degree to which computing resources such as CPU, working memory, storage memory, and network bandwidth are accessible and usable by processes when needed. CPU availability can refer to the proportion of CPU capacity that is free to be allocated to processes. Working memory availability can refer to the amount of RAM that is free and available for use by applications and processes. Storage memory availability can refer to the amount of disk space available for storing data, and network availability can refer to the bandwidth and connectivity that are available for data transmission over a network.

Logging manager repository 108 in history area 2125 can store data specifying ratings of log messages and of logging system 100 over time. Logging manager 110 can utilize such history data of rating for assigning ratings to log messages and/or logging system 100 according to one or more factor. Logging manager repository 108 in history area 2125 can store data on a history of evaluations performed by logging manager 110 on log messages and/or on logging system 100. Based on the history data, logging manager 110 can perform trends analysis and based on the trends analysis can produce action decisions, e.g., to qualify or not qualify log message for ingestion and storage into logging volume 104 or action decision to retain or remove particular logging of particular log message from logging volume 104 after it has been stored.

Logging manager 110 can run various processes. Logging manager 110 running ingestion process 111 can include logging manager 110 storing new log messages into logging volume 104. Logging manager 110 running ingestion process 111 can include logging manager 110 qualifying new log messages for storage into logging volume 104 based on a comparing of a rating of the log message to a rating of logging system 100. Logging manager 110 qualifying new log message for storage into logging volume 104 can include logging manager 110 generating a rating for the new log message, generating a rating for logging system 100, and comparing the log message rating to the logging system rating. Logging manager 110 performing ingestion process 111 can include logging manager 110, e.g., assigning timestamps to newly received log messages.

Logging manager 110 performing log message evaluation process 112 can include logging manager 110 assigning an evaluation rating to orchestrator running evaluation process. Logging manager 110 running log message evaluation process 112 can evaluate a log under multiple factors, e.g., an age of a log message factor, queries factor that references a count of queries of a log message stored within logging volume 104 over time, a topics factor. According to a topics factor, log manager 110 can subject text defining a log message to natural language processing to extract topics from the text data including topics mapping to keywords including topics defined by logging manager 110. Logging manager 110 running log message evaluation process 112 can also include logging manager 110 evaluating log messages under, e.g. a redundancy factor and a size factor.

Logging manager 110 running logging system evaluation process 113 can include logging manager 110 evaluate logging system 100 under a variety of factors and can assign a rating to logging system 100, which can be referred to herein as a logging system pressure rating. Logging manager 110 running logging system evaluation process 113 can include logging manager 110 assigning a rating to logging system 100 in dependence on one or more factor. The one or more factor can include, e.g., a storing rate factor that references a rate at which new log messages are ingested and stored into logging volume 104, a contentions factor which references a contentions level of logging system 100, and an availability factor that references an availability of computing resources defining logging system 100. Computing resources defining logging system 100 can include, e.g., one or more computing node defining logging volume 104 and one or more computing node hosting software for implementing processes, such as processes 111-114, run by logging manager 110.

Logging manager running action decision process 114 can include logging manager 110 producing one or more action decision for management of log messages, e.g., action decision to disqualify or qualify a log message for ingestion, an action decision to delete a log message, an action decision to retain a log message.

Logging manager 110 can run a natural language processing (NLP) process 115 for determining one or more NLP output parameter of a message. NLP process 115 can include one or more of a topic classification process that determines topics of messages and output one or more topic NLP output parameter, a sentiment analysis process which determines sentiment parameter for a message, e.g., polar sentiment NLP output parameters, “negative,” “positive,” and/or non-polar NLP output sentiment parameters, e.g., “anger,” “disgust,” “fear,” “joy;” and/or “sadness” or other classification process for output of one or more other NLP output parameters e.g., one of more “social tendency” NLP output parameter or one or more “writing style” NLP output parameter.

By running of NLP process 115 logging manager 110 can perform a number of processes including one or more of (a) topic classification and output of one or more topic NLP output parameter for a received message (b) sentiment classification and output of one or more sentiment NLP output parameter for a received message or (c) other NLP classifications and output of one or more other NLP output parameter for the received message.

Topic analysis for topic classification and output of NLP output parameters can include topic segmentation to identify several topics within a message. Topic analysis can apply a variety of technologies e.g., one or more of Hidden Markov model (HMM), artificial chains, passage similarities using word co-occurrence, topic modeling, or clustering. Sentiment analysis for sentiment classification and output of one or more sentiment NLP parameter can determine the attitude of a speaker or a writer with respect to some topic or the overall contextual polarity of a document. The attitude may be the author's judgment or evaluation, affective state (the emotional state of the author when writing), or the intended emotional communication (emotional effect the author wishes to have on the reader). In one embodiment sentiment analysis can classify the polarity of a given text as to whether an expressed opinion is positive, negative, or neutral. Advanced sentiment classification can classify beyond a polarity of a given text. Advanced sentiment classification can classify emotional states as sentiment classifications. Sentiment classifications can include the tonal classification of “anger,” “disgust,” “fear,” “joy,” and “sadness.” Logging manager 110 running NLP process 115 can include logging manager 110 returning NLP output parameters in addition to those specification topic and sentiment, e.g., can provide sentence segmentation tags, and part of speech tags. Logging manager 110 can use sentence segmentation parameters to determine e.g., that an action topic and an entity topic are referenced in a common sentence for example.

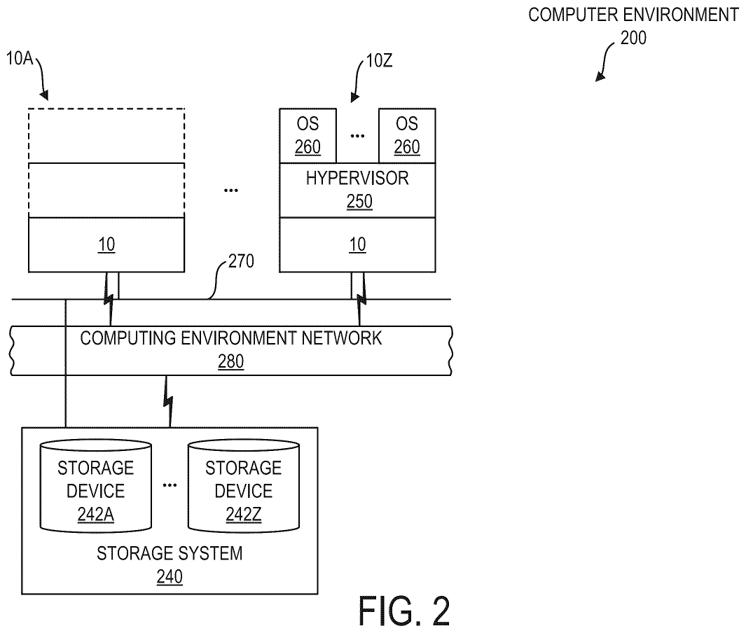

FIG. 2 depicts an example infrastructure defining a computer environment 200 for hosting and defining logging system 100. A computer environment 200 for hosting and defining logging system 100 is set forth in reference to the infrastructure view of FIG. 2. Computer environment 200 can include a plurality of computing nodes 10, which can be provided by physical computing nodes.

The respective computing nodes 10 can have software running thereon defining computing node stacks 10A-10Z. Software defining the respective instances of computing node stacks 10A-10Z can be differentiated between the computing node stacks, e.g. some stacks can provide traditional bare metal machine operation, other stacks can include a hypervisor 250 that supports a plurality of guest operating systems (OS) 260 defining respective guest hypervisor based virtual machines (VMs), other stacks can include container based VMs, e.g. running on top of a hypervisor based VM or running on a computing node stack that is absent of a hypervisor. A plurality of different configurations are possible. Software defining the respective instances of computing node stacks 10A-10Z can include application layer software which when run can perform various processes, e.g., processes of a storage system controller and/or processes 111-114 of logging manager 110.

Referring to further aspects of computer environment 200, computer environment 200 can include storage system 240. Storage system 240 can include storage devices 242A-242Z, which can be provided by physical storage devices. Physical storage devices of storage system 240 can include associated controllers defined by one or more computing node stack of computing node stacks 10A-10Z. Storage devices 242A-242Z can be provided, e.g., by hard disks and Solid-State Storage Devices (SSDs). Storage system 240 can be in communication with computing node stacks 10A-10Z by way of a Storage Area Network (SAN) and/or a Network Attached Storage (NAS) link. According to one embodiment, computer environment 200 can include fibre channel network 270 providing communication between respective computing node stacks 10A-10Z and storage system 240. Fibre channel network 270 can include a physical fibre channel that runs the fibre channel protocol to define a SAN. NAS access to storage system 240 can be provided by computer environment network 280 which can be an IP based network. Network 190 set forth in the logical system view of FIG. 1 can be defined by one or more of fibre channel network 270, and/or computer environment network 280. Computer environment 200 can be configured to provide cloud computing services. Computer environment 200 can be provided, e.g., by one or more data center.

In one embodiment, logging volume 104 can map in infrastructure space to one or more storage device of storage devices 242A-242Z. Likewise, archive storage 106 can map in infrastructure space to one or more storage device of storage devices 242A-242Z. Logging volume 104 can be configured as an indexed database in dependence on application layer software defining one or more computing node stack of computing node stacks 10A-10Z.

Data sources 140A-140Z can be provided e.g. by logging agents disposed appropriately within computer environment 200 for generating log messages, e.g. application log messages, system log messages, security log messages, audit log messages, transaction log messages, and event log messages. Data sources 140A-140Z (FIG. 1) can comprise e.g., logging agents of applications, which produce application log messages, logging agents of operating systems which include system log messages, logging agents which produce security log messages, logging agents which produce audit log messages, logging agents which produce transaction log messages, and logging agents which produce event log messages.

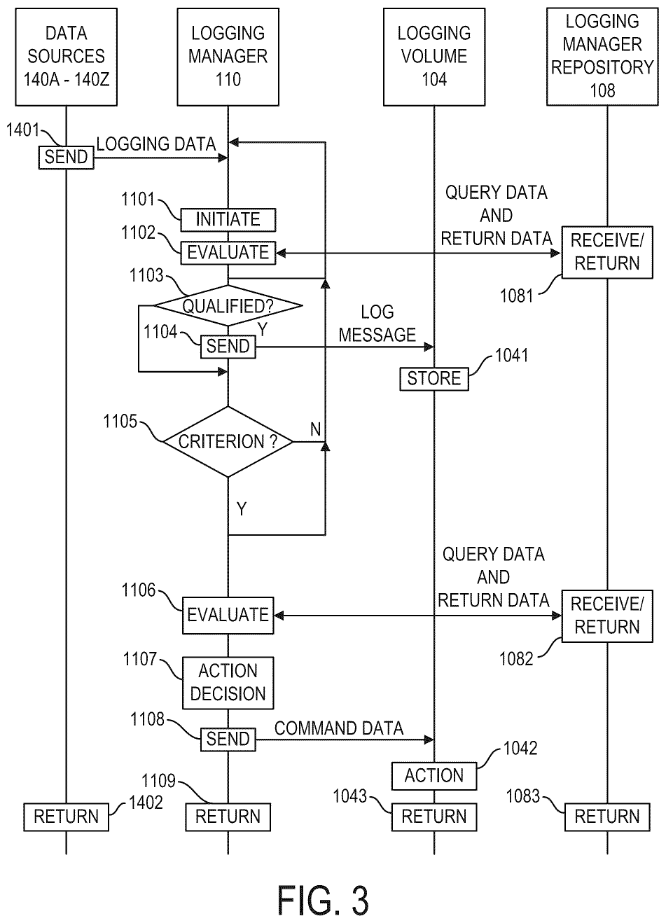

A method for performance by logging manager 110 interoperating with data sources 140A-140Z, logging volume 104, and logging manager repository 108 is set forth in reference to the flowchart of FIG. 3.

At block 1401, data sources 140A-140Z can be iteratively sending logging data defined by log messages for receipt by logging manager 110. Logging manager 110 can initiate ingestion of a new log message at initiate block 1101. At initiate block 1101, logging manager 110 can assign a timestamp to the log message and can proceed to evaluation of the log message at evaluate block 1102. At evaluate block 1102, logging manager 110 can perform evaluation of an incoming log message by running of log message evaluation process 112 and can perform evaluation of logging system 100 by running of logging system evaluation process 113.

Logging manager 110 running evaluate block 1102 can include logging manager 110 evaluating an incoming log message with use of Eq. 1.

$$R L = FL 1 W 1 + F L 2 W 2 + FL 3 W 3 + FL 4 W 4 + F L 4 W 4 + F L 5 W 5 + F L 6 W 6 + F L 7 W 7 \qquad ( Eq . 1 )$$

Where RL is the overall rating assigned to an incoming log message, FL1 is a first factor, FL2 is a second factor, FL3 is a third factor, FL4 is a fourth factor, FL5 is a fifth factor, FL6 is a sixth factor, FL7 is a seventh factor and W1-W7 are weights associated to the various factors.

According to one embodiment, factor FL1 can be logging data source factor. Embodiments herein recognize that log messages can be regarded to have different degrees of importance in dependence on a source of the logging data. Data sources 140A-140 Z can be provided e.g. by logging agents disposed appropriately within computer environment 200 for generating log messages, e.g., application log messages, system log messages, security log messages, audit log messages, transaction log messages, and event log messages. Data sources 140A-140Z (FIG. 1) can comprise e.g., logging agents of applications, which produce application log messages, logging agents of operating systems which include system log messages, logging agents which produce security log messages, logging agents which produce audit log messages, logging agents which produce transaction log messages, and logging agents which produce event log messages.

Logging manager 110 in one embodiment, can employ the decision data structure to Table A for assigning scoring values under factor FL1.

TABLE A

| Row | Data source | Scoring value under factor FL1 |
|---|---|---|
| 1 | logging agent of application | 0.5 |
| | which produces application log | |
| | messages | |
| 2 | logging agent of operating | 0.7 |
| | system which produces system | |
| | log messages | |
| 3 | logging agent which produces | 0.8 |
| | security log messages | |
| 4 | logging agent which produces | 1.0 |
| | audit log messages | |
| 5 | logging agent which produces | 0.5 |
| | transaction log messages | |
| 6 | logging agents which produce | 0.5 |
| | event log messages | |

In reference to Table A, scoring values under factor FL1 can change depending on a current application, can be configured by an administrator user, and/or can be process dependent.

According to one embodiment, factor FL2 can be an age of log message factor. Embodiments herein recognize that log messages can have degraded importance over time. Accordingly, logging manager 110 under factor FL2 can scale assigned scoring values inversely depending on an age of the log message. That means when a log message is first evaluated at initial evaluate block 1102, logging manager 110 can assign highest possible score, e.g., 1.0 on a 0.0 to 1.0 scale at evaluate block 1102 based on the age factor.

Factor FL3 can be a queries level factor. Embodiments herein recognize that query of a stored log message by processes and/or users can indicate an importance of a log message and an indicator that benefits can be produced by retention of the log message. Logging manager 110 under evaluation of factor FL3 can examine a number of queries made on a log message one or more time window. At the ingestion initiate stage depicted at block 1101, the number of queries on a log message being evaluated can be expected to be zero. Accordingly, at evaluate block 1102, logging manager 110 can assign a neutral scoring value to an evaluated log message, e.g., 0.5.

Logging manager under factor FL4 can examine topics referenced within text data defining a log message. For performance of evaluating at evaluate block 1102, logging manager 110 can process a log message using natural language processing to extract one or more topic from the log message. In one embodiment, an extracted topic can be a topic mapping to a keyword of a text-based log message. In one example, log incoming log messages processed at evaluate block 1102 can include log messages as set forth in Table B.

TABLE B
abc42abc91a-abcah.log Databases for Redis: create deployment-backup-scheduled
abc428f898d-p6ach.log Databases for Redis (standard): create backup-scheduled for instance
fasdwada-adwn-ada1-1231-3123131231da
abc428f898d-p6ach.log Databases for Redis: create deployment-backup-scheduled
abc42abc91a-abcah.log Databases for Redis (standard): create backup-scheduled for instance
fasdwada-adwn-ada1-1231-3123131231da
abc428f898d-p6ach.log Databases for Redis: create deployment-backup-scheduled
abc428f898d-p6ach.log Databases for Redis (standard): create backup-scheduled for instance
fasdwada-adwn-ada1-1231-3123131231da
jejna821131-lsefs.log Databases for Redis: create deployment-backup-scheduled
jejna821131-lsefs.log Databases for Redis (standard): create backup-scheduled for instance fasdwada-
adwn-ada1-1231-3123131231da
jejna821131-lsefs.log Databases for Redis: create deployment-backup-scheduled
jejna821131-lsefs.log Databases for Redis (standard): create backup-scheduled for instance fasdwada-
adwn-ada1-1231-3123131231da
abc4278c48-1khwd.log Databases for Redis: create deployment-backup-scheduled
abc4278c48-1khwd.log Databases for Redis (standard): create backup-scheduled for instance
fasdwada-adwn-ada1-1231-3123131231da
abc4278c48-1khwd.log Databases for Redis: create deployment-backup-scheduled
abc4278c48-1khwd.log Databases for Redis (standard): create backup-scheduled for instance
fasdwada-adwn-ada1-1231-3123131231da
abc4278c48-1khwd.log Databases for Redis: update deployment-group
abc4278c48-1khwd.log Databases for Redis (standard): scale resources for instance fasdwada-adwn-
ada1-1231-3123131231da
abc4278c48-1khwd.log Databases for Redis: update deployment-group-autoscaling
abc4278c48-1khwd.log Databases for Redis (standard): update autoscaling for instance fasdwada-
adwn-ada1-1231-3123131231da
abc4278c48-1khwd.log Databases for Redis: update deployment-group-autoscaling
abc4278c48-1khwd.log Databases for Redis (standard): update autoscaling for instance fasdwada-
adwn-ada1-1231-3123131231da
abc4278c48-1khwd.log Databases for Redis: update deployment-group
abc4278c48-1khwd.log Databases for Redis (standard): scale resources for instance fasdwada-adwn-
ada1-1231-3123131231da
abc4278c48-1khwd.log Databases for Redis: update deployment-group
abc4278c48-1khwd.log Databases for Redis (standard): scale resources for instance fasdwada-adwn-
ada1-1231-3123131231da
abc4278c48-1khwd.log Databases for Redis: update deployment-group
abc4278c48-1khwd.log Databases for Redis (standard): scale resources for instance fasdwada-adwn-
ada1-1231-3123131231da
abc4278c48-1khwd.log Databases for Redis: create deployment-backup-scheduled

In reference to the incoming log messages of Table B, logging manager 110 performing natural language processing can extract the keyword topic “backup” for first messages of the log messages and can extract the topic “scaling of resources” for second messages of the log messages. In one embodiment, the extracted topic can be an extracted text keyword that specifies a level of the log message, e.g., trace, fatal (critical), error, warning, info, debug, audit and the like. In some instances, a log message can be absent of a topic keyword that specifies a log level, e.g., trace, fatal (critical), error, warning, info, debug, audit and the like, yet logging manager 110 can perform natural language processing to extract a topic mapping to a log level, e.g., trace, fatal (critical), error, warning, info, debug, audit. Logging manager 110 under factor FL4 can apply scoring values under factor FL4 using the decision data structure of Table C.

TABLE C

| Row | Extracted topic (e.g., log level) | Scoring value |
|---|---|---|
| 1 | Fatal (critical) | 1.0 |
| 2 | Audit | 1.0 |
| 3 | Error | 0.7 |
| 4 | Warning | 0.6 |
| 5 | Info | 0.5 |
| 6 | Scaling of resources | 0.4 |
| 7 | Debug | 0.3 |
| 8 | Backup | 0.2 |
| 9 | Trace | 0.1 |

As set forth in Table C, certain topics can be assigned increased ratings under factor FL4. Where logging manager 110 assigning scoring values under factor FL4 can include logging manager 110 assigning scoring valued in dependence on an extracted log level, factor FL4 can be regarded as a log level factor.

Logging manager 110 under factor FL5 can evaluate redundancy of a log message. In performing evaluation of redundancy of log message, logging manager 110 can apply various processes. According to one embodiment, logging manager assigning scoring values under factor FL5 can generate a hash of a current log message being evaluated and compare the hash to hashes previously determined for log messages stored within logging volume 104. Where the hash of the log message being evaluated is the same as the hash of the previously stored log message, logging manager 110 can determine that the current log message being evaluated is redundant to a prior stored log message and can assign a low, e.g., 0.0 score scoring value under factor FL5. In another aspect, logging manager 110 can scale scoring values under factor FL5 in dependence on a degree of similarity of a hash of the current log message being evaluated to the most similar hash of remaining log messages stored in logging volume 104.

In another aspect, logging manager 110 in evaluating factor FL5 can generate a vector representation of the semantic meaning of the current log message and can compare that vector representation to vector representation of semantic meanings of remaining stored log messages currently stored within logging volume 104.

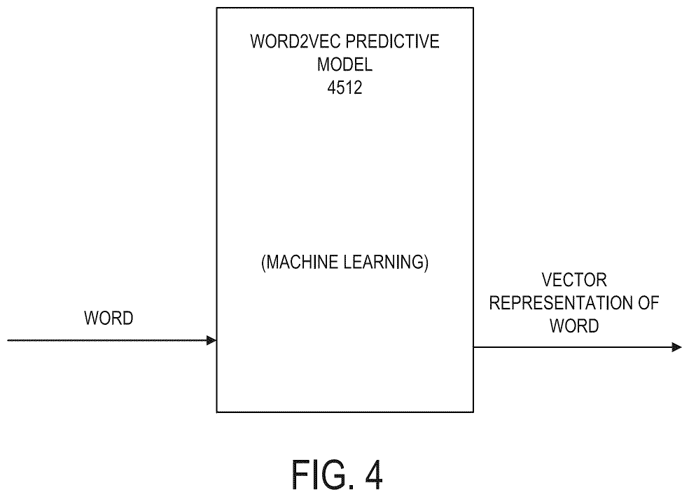

Logging manager 110, in one embodiment, can employ word2vec predictive model 4512 as set forth in FIG. 4 for determination of vector representation of a word. For performance of evaluating under factor FL5, logging manager 110 can input text segments defining log message into word2vec predictive model 4512 for return of a vector representation of a text segment defining a log message. Logging manager 110 can employ word2vec predictive model 4512 to determine similarity between multi-segment messages by aggregating the segment embeddings into a single vector representation for each multi-segment log message. Logging manager 110 according to one example can perform preprocessing of log messages to tokenize them and remove stop words, then average the word2vec embeddings of the remaining segments to create a multi-segment-level embedding. With multi-segment level embeddings established, logging manager 110 can compare the embeddings, e.g., based on Euclidian distance. Logging manager 110 can scale scoring values under factor FL5 in dependence on a degree of similarity of semantic meaning of current log message being evaluated to the most similar semantic meaning extracted from remaining log messages stored in logging volume 104.

Redundancy analysis under factor FL5 can also or alternatively include, e.g., identifying key attributes, pattern matching, frequency analysis, and time window analysis.

Regarding factor FL6, factor FL6 can be a size factor. Logging manager 110 assigning scoring values under factor FL6 can inversely scale scoring values under factor FL6 in dependence on a size of a log message, e.g., in terms of consumed storage bytes. Such scoring can be based on the theory that shorter log messages have greater value per line than longer log messages. Such scoring can also advantageously drive the discarding and removal of longer more space consuming log messages.

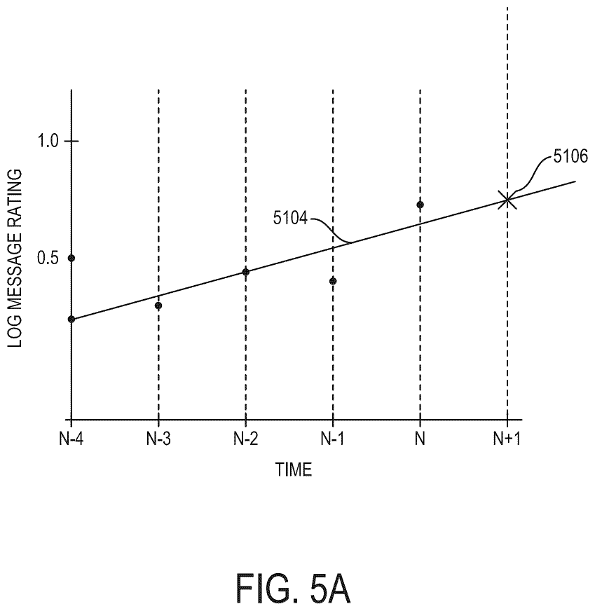

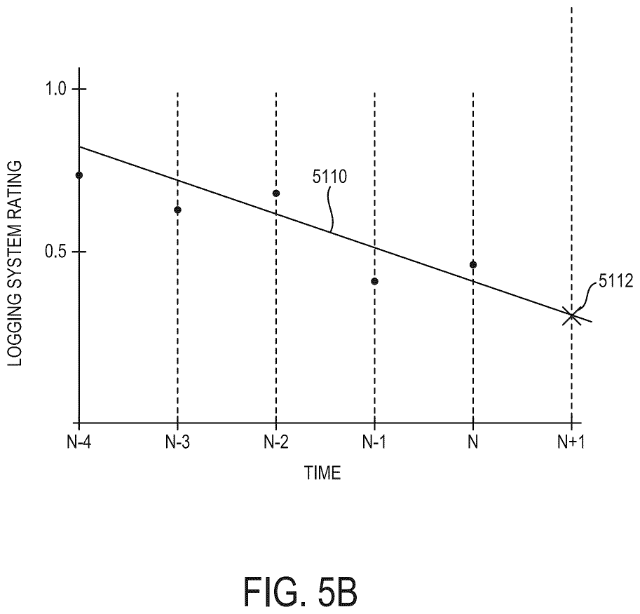

Regarding factor FL7, factor FL7 can be a trends factor. Referring to FIG. 5A, logging manager 110 can determine a trend of a log message rating in dependence on a history of evaluations of the log message over time. Referring to FIG. 5A, logging manager 110 for a particular log message can query a regression based machine learning predictive model having attributes set forth in reference to FIG. 5A, wherein there are depicted evaluation ratings over time, and iteratively reconfigured regression line 5104 that can be iteratively reconfigured with each new iteration of log message rating data that can be applied as training data to reconfigure regression line 5104. Logging manager 110 can scale scoring values under factor FL7 in dependence on a predicted rating (data point 5106) of the log message at the future time N+1 based on the regression line 5104 and/or in dependence on a slope of regression line 5104. It will be understood that at evaluate block 1102 there will be no historical rating trend information available for new incoming log message being processed for qualifying for ingestion. Accordingly, at evaluate block 1102 logging manager 110 can assign a neutral scoring value under factor FL7, e.g., 0.5. However, once a log message is stored into logging volume 104 and subject to iterations of evaluations, logging manager 110 at evaluate block 1106 to be described later herein can scale scoring values under factor FL7 in dependence on regression line 5104.

Accordingly, there is set forth herein according to one embodiment, in reference to Eq. 1, generating log messages from one or more data source; evaluating one or more log message produced from the generating, and outputting, in dependence on the evaluating the one or more log message, a log message rating of the one or more log message; evaluating a logging system, and outputting, in dependence on the evaluating the logging system, a logging system rating of the logging system, wherein the logging system includes a logging volume for storing log messages; comparing the log message rating to the logging system rating; and producing an action decision impacting a count of log messages stored in the storage volume in dependence on the comparing of the log message rating, and the logging system rating, wherein the evaluating the one or more log message produced from the generating, and outputting, in dependence on the evaluating the one or more log message, the log message rating of the one or more log message, includes evaluating multiple log message importance factors, wherein first and second ones of the multiple log message importance factors include differentiated factors selected from the group consisting of (a) a source factor in dependence on a data source generating the one or more log message, (b) an age factor in dependence on an age of the one or more log message, (c) a queries factor in dependence on a current rate at which the one or more log message is being queried, (d) a log level factor in dependence on an age of the one or more log message, (e) a redundancy factor in dependence on level of similarity of the one or more log message to a stored log message of the logging volume, (f) a size factor in dependence on a number of characters defining the one or more log message, and (g) a trend factor in dependence on a history of a rating assigned to the one or more log message over time.

With the scoring under factors FL1, FL2, FL3, FL4, FL5, FL6, and FL7 applied as described, logging manager 110 can output a current overall rating RL for one or more log message.

At evaluate block 1102, logging manager 110 can further evaluate logging system 100 with use of log system evaluation process 113 in order to derive a rating current reading which can be determined termed a pressure rating of logging system 100.

In performing evaluating of logging system 100 at evaluate block 1102, logging manager 110 can apply Eq. 2.

$$R S = FS 1 W 1 + F S 2 W 2 + F S 3 W 3 + F S 4 W 4 + F S 4 W 4 \qquad ( Eq . 2 )$$

Where RS is the overall logging system rating value, as where FS1, FS2, FS3, and FS4 are factors impacting the evaluation and W1-W4 are weights associated to the various factors. Logging manager 110 evaluating logging system 100 under factor FS1 can apply scoring values under factor FS1 based on a current log message ingestion rate, e.g., as recorded in logging manager repository 108 based on one or more time window.

According to one embodiment, logging manager 110 can scale scoring values under factor FS1 in dependence on a current rate of log message storage events as can be discovered by query of log events area 2122 of logging manager repository 108. Where the rate of log message storage is at a rate higher than a baseline level, logging manager 110 can assign a higher than baseline scoring value under factor FS1.

Referring to factor FS2, logging manager 110 can scale scoring values under factor FS2 in dependence on a current rate of contentions with respect to logging volume 104. Embodiments herein recognize that logging volume 104 can be subject to contentions from other of a variety of sources. In one use case scenario, a logging contention can be observed when multiple processes try to read from or write to a storage device, such as a storage device defining logging volume 104 at the same time. Contentions can lead to longer wait times for I/O operations and can reduce overall system throughput. In one example, logging manager 110 can be ingesting new log message and various processes can be querying prior stored log messages.

Logging manager 110 assigning scoring values under factor FS2 can assign scoring values independent on a current rate of contentions on logging volume 104. Logging manager 110 can assign higher than baseline scoring values under factor FS2 where the current rate of contentions on logging volume 104 is higher than baseline and can assign lower than baseline scoring values under factor FS2 where the rate of contentions on logging volume 104 is lower than the baseline value.

Logging manager 110 assigning scoring values under factor FS3 can scale scoring values inversely dependent on a computing resource availability of computing resources of one or more computing node hosting and defining logging volume 104, one or more computing node hosting and defining logging manager 110, i.e., the one or more computing node on which application layer software runs for performance of processes 111-115, and/or of computing resources defining network 190 (FIG. 1) facilitating transmission of log messages from data sources 140A-140Z to logging manager 110. Computing resource availability can specify, e.g., the degree to which computing resources such as CPU, working memory, storage memory, and network bandwidth are accessible and usable by processes when needed. CPU availability can refer to the proportion of CPU capacity that is free to be allocated to processes. Working memory availability can refer to the amount of RAM that is free and available for use by applications and processes. Storage memory availability can refer to the amount of disk space available for storing data, and network availability can refer to the bandwidth and connectivity that are available for data transmission over a network.

Logging manager 110 can assign higher than baseline scoring values under factor FS3 when a current availability of the described computing resources is lower than a baseline value and can assign lower than baseline scoring value under factor FS3, where current availability of the described computing resources is higher than a baseline value.

Regarding factor FS4, factor FS4 can be a trends factor. Referring to FIG. 5B, logging manager 110 can determine a trend of a logging system rating in dependence on a history of evaluations of logging system 100 over time. Referring to FIG. 5B, logging manager 110 for evaluating logging system 100 under factor FS4 can query a regression based machine learning predictive model having attributes set forth in reference to FIG. 5B, wherein there are depicted logging system evaluation ratings over time, and iteratively reconfigured regression line 5110 that can be iteratively reconfigured with each new iteration of logging system rating data that can be applied as training data to reconfigure regression line 5110. Logging manager 110 can scale scoring values under factor FS4 in dependence on a predicted rating of the log message at the future time N+1 (data point 5112) based on the regression line 5110 and/or in dependence on a slope of the iteratively reconfigured regression line 5110.

Accordingly, there is set forth herein according to one embodiment, in reference to Eq. 2, generating log messages from one or more data source; evaluating one or more log message produced from the generating, and outputting, in dependence on the evaluating the one or more log message, a log message rating of the one or more log message; evaluating a logging system, and outputting, in dependence on the evaluating the logging system, a logging system rating of the logging system, wherein the logging system includes a logging volume for storing log messages; comparing the log message rating to the logging system rating; and producing an action decision impacting a count of log messages stored in the storage volume in dependence on the comparing of the log message rating, and the logging system rating, wherein the evaluating the logging system, and outputting, in dependence on the evaluating the logging system, the logging system rating of the logging system includes evaluating multiple logging system pressure factors, wherein first and second ones of the multiple logging system pressure factors include differentiated factors selected from the group consisting of (a) an ingestion rate factor in dependence on a current rate at which new log messages are being ingested into the logging volume, (b) a contentions factor in dependence on current rate of contentions recorded for the logging volume, (c) an availability factor in dependence on current computing resource availability for a computing node defining the logging volume, and (d) a trend factor in dependence on a history of ratings assigned to the logging system over time.

With the scoring under factors FS1, FS2, FS3, and FS4 applied as described, logging manager 110 can output a current overall rating RS for logging system 100 that specifies a current pressure on logging system 100.

At evaluate block 1102, logging manager 110 can compare a current rating RL (Eq. 1) assigned to a current log message being evaluated to a current rating RS (Eq. 2) assigned to logging system 100.

In one aspect, both the log message rating RL and the logging system scale rating RS can be established to have a common scale, e.g., a common numerical sale defined by the scale 0.0 to 1.0. Providing the log message rating RL and the logging system scale rating RS to have a common scale can facilitate performing a comparing between the two distinct measurements. In another aspect, one or both of the log message rating RL and the logging system scale rating RS can be based on multiple factors as set forth in reference to Eq. 1 and Eq. 2 which multiple factors can be reduced (Eq. 1 and Eq. 2) to a single numerical value for facilitation of comparison between a log message rating RL and the logging system scale rating RS.

As depicted by receive/return block 1081 and receive/return block 1082 evaluations at evaluate block 1102 and evaluate block 1106 can include multiple queries on logging manager repository 108.

In another aspect, logging manager 110 at evaluate block 1102 and/or evaluate block 1106 (to be described further herein) can, on completion of evaluating with use of Eq. 1 and/or Eq. 2 store evaluation results for log messages evaluated and/or evaluations of logging system 100 on completion of the evaluations so that history area 2125 stores a history of ratings assigned to log messages and/or logging system 100 over time. Logging manager 110 can subsequently query the logging history data for return of action decisions.

Logging manager 110 at qualified action decision block 1103 can qualify a current log message for ingestion and storage into logging volume 104 where a rating assigned to the log message satisfies a threshold determined in dependence on current rating assigned to logging system 100. For example, logging manager 110 can qualify a log message for ingestion when its rating RL exceeds, or alternatively is equal to or exceeds the current rating RS of logging system 100.

Accordingly, the processing described establishes a dynamic and flexible criterion for entry or nonentry of new log message. For instance, the same log message evaluated at different times may be qualified for storage into logging volume 104 or not qualified in dependence on a current pressure exhibited on logging system 100. For example, at times of relatively low pressure reflected by a current rating assigned to logging system 100, logging system 100 can accommodate additional storage of log messages and new log messages being evaluated are more likely to be qualified for storage into logging volume 104. On the other hand, at times of relatively high pressure on logging system 100 as reflected in the current rating applied to logging system 100, logging manager 110 may disqualify the same log message for storage into logging volume 104 and thereby logging manager 110 in logging system 100 can improve the performance of logging system 100 by adaptively rejecting new log messages and protecting and reducing risk to logging system 100 where pressure on logging system 100 is relatively high. At the same time, logging manager 110 can improve performance of logging volume 104 and logging system 100 by permitting additional decision driving and enriching log messages where it is determined the storage of such additional log messages can be performed with reduced likelihood of negative impact on logging system 100.

Logging manager 110 on determining at qualified decision block 1103 that at incoming log message is qualified for ingestion and storage into logging volume 104 can proceed to send block 1104. At send block 1104, logging manager 110 can send the log message evaluated at evaluate block 1102 to logging volume 104 for ingestion and storage into logging volume 104 at store block 1041.

In another aspect, logging manager 110 from time to time can evaluate multiple, e.g., all log messages currently stored within logging volume 104 in combination with evaluating logging system 100 for determination of whether one or more log messages from the multiple log messages should be deleted from logging volume 104.

On completion of send block 1104, logging manager 110 can proceed to criterion block 1105. At criterion block 1105, logging manager 110 can, in dependence on one or more criterion being satisfied, proceed to performing evaluating of multiple log messages stored within logging volume 104 in combination with evaluating logging system 100.

The one or more criterion active at criterion block 1105 can be, e.g., a periodic schedule criterion. That is, in one aspect, logging manager 110 can be configured to periodically perform an evaluation of multiple log messages stored in logging volume 104 in combination with evaluating logging system 100 on a periodic basis, e.g., at predetermined time intervals or dynamically determined time intervals. In one aspect, logging manager 110 at decision criterion block 1105 can ascertain whether a current time coincides with the scheduled time for performance of a periodic evaluation of multiple log messages within logging volume 104 in combination with an evaluating of logging system 100, and if the current time coincides with the scheduled time for performance of a periodic evaluation, logging manager 110 at criterion block 1105 can proceed to evaluate block 1106.

The one or more criterion that can be active at criterion block 1105 can, in one embodiment, include a logging system rating criterion. In one aspect, logging manager 110 can be configured to perform evaluating of multiple log messages in combination with performing evaluating of logging system 100 on satisfaction of the criterion that a current rating for logging system 110 has satisfied a threshold rating, indicative e.g. of threshold satisfying amount of pressure on logging system 100. Embodiments herein recognize that where a rating of a current rating of logging system 100, e.g., as performed at a most recent iteration of evaluate block 1102 satisfies a threshold, logging system 100 can benefit from a reduction of stored log message stored within logging volume 104. In another example of one or more criterion that can be active at criterion block 1105, logging manager 110 can proceed to performing an evaluation of multiple log messages stored within logging volume 104 in combination with evaluating logging system 100 based on a trend exhibited by a rating assigned to logging system 100 over time. In one example, logging manager 110 can be configured to iteratively calculate a current rate of change of a current rating assigned to logging system 100 over multiple different time windows, e.g., a 10 second time window, 10-minute time window, one hour time window, one day time window, and the like.

Logging manager 110 in one embodiment can be configured so that a criterion of criterion block 1105 is satisfied on the determination by logging manager 110 at criterion block 1105 that rate of increase of a rating assigned to logging manager 110 has satisfied a threshold rate increase.

On determining at criterion block 1105 that one or more criterion for proceeding to performing evaluating of multiple log messages stored in logging volume 104 in combination with evaluating logging system 100 has been satisfied, logging manager 110 can proceed to evaluate block 1106.

On the determination at criterion block 1105 that no criterion has been satisfied for proceeding to evaluate block 1106, logging manager 110 at criterion block 1105 can return to a stage prior to ingestion initiation block 1101 to iteratively perform the loop of blocks 1101-1105 until at block 1105 it is determined that a criterion for proceeding to evaluate block 1105 has been satisfied. Further, as depicted by flowchart at FIG. 3, logging manager 110 even on the determination that the criterion that one or more criterion at criterion block 1105 is satisfied for proceeding to evaluate block 1106, logging manager 110 can still return to a stage preceding block 1101 to iteratively perform the loop of blocks 1101-1105 while simultaneously branching to perform processing initiated at evaluate block 1106.

Regarding evaluate block 1106, logging manager 110 at evaluate block 1106 can perform evaluating of multiple log messages currently stored in logging volume 104 in combination with evaluating logging system 100. At evaluate block 1106, logging manager 110 can evaluate multiple, e.g., all log messages currently stored within logging volume 104 in combination with evaluating logging system 100. For performing evaluating at evaluate block 1106, logging manager 110 can employ the same equations Eq. 1 and Eq. 2 for evaluating log messages in logging volume 104 and logging system 100 respectively as was applied at evaluate block 1102.

Although the same Eq. 1 and Eq. 2 can be employed for evaluating log messages and logging system 100 respectively at evaluate block 1102 and evaluate block 1106, there can be practical differences in results returned at evaluate block 1106 as compared to results returned evaluate block 1102. In one aspect with reference to Eq. 1, the scoring values applied by logging manager 110 under factor FL1 can be different as between evaluate block 1102 and evaluate block 1106.

At evaluate block 1102, logging manager 110 when applying scoring values under factor FL1 can assign a highest possible score, e.g., 1.0 on a scale of 0.0-1.0 given the fact that evaluate block 1102 the log message being evaluated will be new, i.e., the youngest possible age. However, at evaluate block 1106, evaluated log messages can have a range of ages and logging manager 110 assigning scoring values under factor FL1 can scale scoring values in dependence on the different ages of the different log messages being evaluated at evaluate block 1106.

Younger, i.e., newer log messages can be assigned relatively higher scores under factor FL1 and relatively aged log messages can be assigned lower scoring values under factor FL1 making it more likely (as a result of the lower FL1 scoring value) that the particular log message will be identified for removal from logging volume 104.

In another aspect, logging manager 110 applying scoring values under factor FL1 at evaluate block 1102 can assign a neutral scoring value, e.g., 0.5 under factor F given that no queries have yet been received for the log message evaluated at evaluate block 1102. However, when logging manager 110 performs evaluate block 1106, logging volume query data will be known for the respective log messages and therefore, logging manager 110 when performing evaluate block 1106 can assign scoring values under factor FL2 in dependence on a number of queries over time received for the particular log message for the log message being evaluated at evaluate block 1106.

In another aspect, logging manager 110 applying scoring values under factor FL7 at evaluate block 1102 can assign a neutral scoring value, e.g., 0.5 under factor FL7 given that no trend information will be available for a given log message prior to its ingestion. However, when logging manager 110 performs evaluate block 1106, such trends information will be available. At evaluate block 1106, logging manager 110 can scale scoring values under factor FL7 for each stored log message being evaluated in dependence on a predicted rating of the log message at the future time N+1 based on the regression line 5104 and/or in dependence on a slope of regression line 5104.

When generating a rating for logging system 100 at evaluate block 1106, the rating RS for logging system 100 can be different in dependence on changes in, e.g., current ingestion rate, current rate of contentions, and current availability as between the time of performance of evaluate block 1102 and evaluate block 1106.

With further reference to evaluate block 1106, logging manager 110 at evaluate block 1106 can, once logging manager 110 has assigned a rating, e.g., importance rating to each of the multiple log messages evaluated at evaluate block 1106, e.g., which can include, in one embodiment, all log message stored within logging volume 104, produce a ranked ordered list ranking all of the evaluated log messages in order of the ranking, e.g., importance ranking produced by logging manager 110 at evaluate block 1106.

On completion of evaluate block 1106, logging manager 110 can proceed to action decision block 1107. At action decision block 1107, logging manager 110 can produce an action decision in dependence on the evaluating performed at evaluate block 1106. In one example of an action decision produced at action decision block 1107, logging manager 110 can return the action decision to remove from logging volume 104 all log messages evaluated at evaluate block 1106 having importance ratings satisfying a threshold determined in dependence on a current pressure rating assigned to logging system 100 using Eq. 2 at evaluate block 1106. For example, logging manager 110 can qualify a log message for retaining at action decision block 1107 when its rating RL exceeds, or alternatively is equal to or exceeds the current rating RS of logging system 100 determined at evaluate block 1106.

Based on the action decision returned at block 1107, logging manager 110 can proceed to send block 1108. At send block 1108, logging manager 110 can send command data to logging volume 104 for implementation of the action decision at block 1107. In one example, command data sent at block 1108 can include command data to delete and remove the identified log messages identified for removal at action decision block 1107. In response to receipt of the command data at block 1108, logging volume 104 can perform at action block 1042 the action specified by the command data sent at block 1108. On completion of action block 1042, logging volume 104 can proceed to return block 1043. At return block 1043, logging volume 104 can return to a stage preceding block 1041. Logging volume 104 can be iteratively performing the loop of block 1041-1043 for a deployment period of logging volume 104. On completion of send block 1108, logging manager 110 can proceed to return block 1109. At return block 1109, logging manager 110 can return to a stage preceding block 1101. Logging manager 110 can be iteratively performing the loop of block 1101-1109 for a deployment period of logging manager 110. Data sources 140A-140Z can be iteratively performing the loop of blocks 1401-1402 for a deployment period of data sources 140A-140Z. Logging manager repository 108 can be iteratively performing the loop of blocks 1081-1083 or a deployment period of logging manager repository 108.

Logging manager 110 in one embodiment at action decision block 1107 can determine first and second thresholds in dependence on current rating assigned to logging system 100 and can return first and second action decisions for respective log messages stored in logging volume 104 in dependence on the thresholds. Logging manager 110 in one embodiment can employ the decision data structure of Table D for return of action decisions at action decision block 1107.

TABLE D

| Row | Condition | Action decision |
|---|---|---|
| 1 | Log message rating is | Retain log message in |
| | greater than or equal to | logging volume 104 |
| | logging system rating | |
| | (log message rating | |
| | satisfies first threshold | |
| | set to coincide with | |
| | logging system rating) | |
| 2 | Log message rating is | Delete log message from |
| | greater than or equal to | logging volume 104 |
| | N % of logging system | and store log message to |
| | rating (log message | archive storage 106 |
| | rating satisfies second | |
| | threshold set to | |
| | coincide level at N % of | |
| | logging system) | |
| 3 | Log message rating is | Delete log message from |
| | less than N % of logging | logging volume 104 |
| | system rating (log | without storing log |
| | message rating does not | message to archive storage. |
| | satisfy second threshold) | |

Referring the action decisions of Table D, logging manager 110 can return action decisions to retain a log message in logging volume 104 where the log message rating of the log message satisfies a first threshold, delete the log message from logging volume 104 but store the log message to archive storage 106 where the log message rating satisfies a second threshold, and delete the log message from logging volume 104 without storing the log message to archive storage 106 where the log message rating does not satisfy the second threshold.

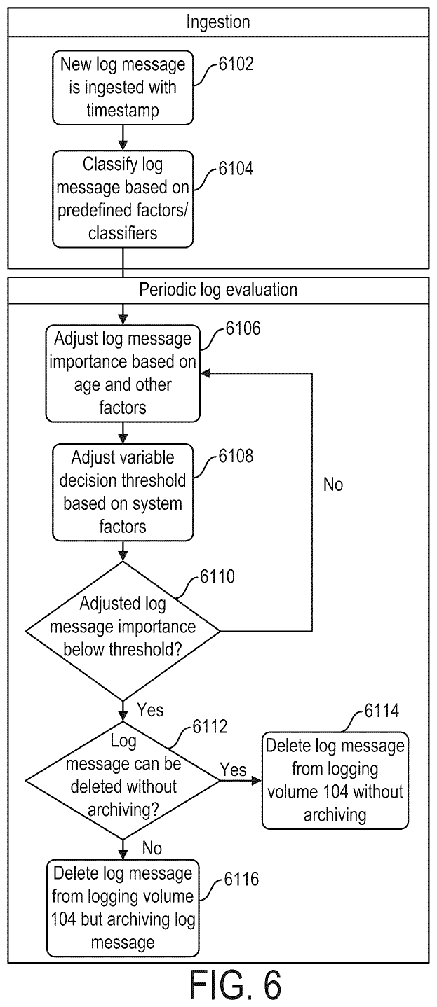

Embodiments herein can include performance of the method set forth in reference to FIG. 6. At block 6102, logging manager 110 can ingest a new log message into logging volume 104. At block 6104, logging manager 110 can classify a log message based on predetermined factors/classification, e.g., the factors of Eq. 1 that do not change over time. At block 6106, logging manager 110 can adjust a log message importance, e.g., based on time variable factors of Eq. 1. At block 6108, logging manager can adjust a variable decision threshold, e.g., by re-evaluating logging system 100 using Eq. 2. At block 6110, logging manager 110 can ascertain whether the adjusted log importance is below the variable decision threshold and if no can iteratively perform the loop of blocks 6106 through 6110 until logging manager 110 returns a YES decision at block 6110. When logging manager 110 returns a YES decision at block 6112, logging manager 110 can proceed to decision block 6112. At decision block 6112, logging manager can determine whether a log message can be deleted from logging volume 104 without archiving. If yes, logging manager 110 can proceed to block 6114 to perform the deletion without arching. If no, logging manager 110 can proceed to block 6116 to perform deletion with archiving into archive storage 106.

There is set forth herein, according to one embodiment, a method for double-dynamically managing log volume in a logging system during runtime, based on both the importance rating of a log event and the pressure rating of the system.

Embodiments herein recognize that storing large amounts of logging data can consume storage and system resources. Embodiments herein recognize that initiatives to store as much as possible log information to solve customer problems or perform preventive maintenance can conflict with cost to store the beneficial information.

Embodiments herein recognize that existing logging products reduce the amount of logging data that is ingested by either implementing static quotas for the logging data of different source systems or by defining filter rules to prevent the ingestion of certain types of log messages. Embodiments herein recognize that static log quotas log ingestion filter rules have the disadvantage of when such a quota is reached important log data is discarded, even when a logging system is capable of injecting the logging data. Embodiments herein recognize that existing logging products also allow to delete or archive log data after a given time period to reduce the amount of stored log data. Embodiments herein recognize deficiencies with such a design. In one aspect, an existing logging system can discard log messages that it is capable of retaining, thus unnecessarily removing prospective decision enriching data. Further, the design can permit discarding of log messages independent of an importance of a log message, and independent of whether an importance of a log message has increased over time.

Embodiments herein can include a method to reduce the number of ingested log messages stored in a logging volume and the number of retained log messages after ingestion and storage. The method can be based on multiple criterion. The first criterion can be the actual importance rating of a given log message. The second criterion can be a pressure rating based on the runtime and storage costs that the system can handle at a given point in time. Both the importance rating and the pressure rating can be point-in-time values that are iteratively re-adjusted. Logging system 100 herein can be configured to ingest and store a more optimized amount of data for the right time frame that is needed to operate logging system 100 with confidence while keeping the costs for ingesting and storing log messages low.

Embodiments herein can include logging agents and/or a logging aggregation sending time-stamped textual log messages to logging manager 110, logging manager 110 receiving said log message, a log volume 104 where logging manager 110 is storing received log messages, a persistent index included in the logging volume 104 wherein logging manager 110 is storing log messages. Embodiments herein can store index information respecting received log messages and can use the index to identify which log messages can match a search query.

Logging manager 110 can maintain an importance rating of log messages in dependence on or more factor, which can include, e.g., age of a message, a redundancy factor, a number of queries of the log message. Logging manager 110 can create an initial importance rating of log messages stored in an indexed logging volume, e.g., logging volume 104 (which can be indexed) based on static factors like: log message data source which is sending the logging data, topic, and the like.

Logging manager 110 can iteratively adjust the importance rating of log messages stored in an indexed logging volume based on dynamic factors like: a number of queries received on respective log messages over time, a redundancy of a log message, a data source of a log message (where scoring values attributable to different data sources can change over time), an age of a log message and the like.

In one aspect, logging manager 110 can define an a ingestion quota that determines how many log messages can be stored into logging volume 104 over a time period, a metering component in logging system 100 measuring how many log messages have been stored within a logging volume 104 over a time period, a metering component measuring contention on logging volume 104, a metering component measuring computing resource availability of one or more computing node defining logging volume 104 and/or logging manager 110. Embodiments herein can include configuring logging manager 110 to maintain a pressure rating of logging system 100 based, e.g., on current ingestion quota, computing resource availability, customer defined cost allowances, contentions, and the like.

Embodiments herein can include logging manager 110 maintaining a pressure rating of logging system 100 based on the same scale as said importance rating such that both ratings can be compared. Embodiments herein can include logging manager 110 excluding log messages from being stored and indexed if its first initial and dynamic importance rating is less than a determined pressure rating of logging system 100 determined by logging manager 110. Embodiments herein can include logging manager 110 removing and/or compressing stored log messages if their importance rating drops below the pressure rating of logging system 100.

Embodiments herein can include use of “double dynamics”. The first dynamic is defining the “importance of a log message” at a given point in time. That importance can be based on the content of the log message and additional information such as the age of the log message, the data source producing the log message and the given log level of a log message.

Embodiments herein can utilize a variety of log message information and condense the information into a single iteratively determined “importance rating” numerical rating for each log message that can vary over time. Embodiments herein can iteratively determine a current system pressure rating that is for example influenced by the amount of ingested loglines of used storage of logging volume 104. Embodiments herein can condense system pressure into a single iteratively determined “pressure rating” which again can vary over time. Logging manager 110 can produce an importance rating of a log message and a pressure rating on a logging system on a common numerical scale that facilitates comparison between a log message rating and logging system rating. Logging manager 110 can iteratively produce an importance rating of a log message and can iteratively produce a pressure rating specifying pressure on a logging system on a common numerical scale that facilitates comparison between an iteratively determined log message rating and iteratively determined logging system rating. On ingesting a log message, logging manager 110 can compare the actual “importance rating” of the log message with the actual current “pressure rating” of logging system 100 and use the comparison to decide whether that log message is at this point of time important enough to be stored given the actual current logging system load and cost as expressing in the pressure rating. Subsequent to ingesting a log message, logging manager 110 can iteratively determine and compare the actual “importance rating” of the log message with the actual iteratively determined current “pressure rating” of logging system 100 and use the comparison to decide whether that log message is at this point of time important enough to be stored given the actual current logging system load and cost as expressing in the pressure rating.

By contrast to simple parameter-based decisions embodiments herein facilitate to maintaining of as much log message information as possible in relation to a logging system pressure and only deleting log message information when the logging system pressure (cost) is forcing it.

Various available tools, libraries, and/or services can be utilized for implementation of trained predictive models herein trained by machine learning. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Trained predictive models herein can employ use, e.g., of artificial neural networks (ANNs), regression based predictive models, random forests, support vector machines (SVM), Bayesian networks, and/or other machine learning technologies.

Certain embodiments herein may offer various technical computing advantages involving computing advantages to address problems arising in the realm of computer systems. Embodiments herein can improve performance of a logging system in multiple ways. Embodiments herein can iteratively evaluate a logging system and criterion for qualifying log messages for ingestion and/or for remaining stored in a logging volume can dynamically adapt in dependence on the iterative evaluation of the logging system. As such, a logging system can adaptively adjust to permit storage of additional log messages when an evaluated risk to a logging system is relatively low and can adaptively adjust to reduce risk to a logging system when an evaluated risk to the logging system is relatively high. Embodiments herein can provide both reduced risk to a logging system and an expansion of decision driving and enriching log messages that can be retained relative to an alternative logging system absent of processes set forth herein. Embodiments herein can improve performance of a logging system by iteratively performing a combined evaluation of stored log messages of logging system and removing stored log messages based on a determination that the stored log messages have importance ratings less than a pressure rating on the logging system. Embodiments herein can dynamically adapt to store within a logging volume additional log messages in cases where pressure on a logging system is relatively low, therefore count of log messages retained in a logging volume can increase adaptively in dependence on a current pressure rating of a logging volume to permit additional retention log messages where it is determined that additional log messages can be stored without a negatively impacting a logging system. Embodiments herein can dynamically adapt to retain certain log messages even in cases where a determined pressure rating of a logging system remains the same or even increases. With iterative evaluation of a logging system there can be performed iterative evaluation of stored log messages including a certain log message. An increase in an importance rating to a certain log message can result in the certain log message being retained, even where a pressure rating assigned to the logging system remains the same or increases. In one example, an increased rate of queries recorded for a certain log message can result in an importance rating for the certain log message increasing. By leveraging data structures to organize relationships between entities, the techniques described herein can reduce computational resources that are expended in locating content that can be surfaced for the performance of processes as described herein. Various decision data structures can be used to drive artificial intelligence (AI) decision making. Decision data structures as set forth herein can be updated by machine learning so that accuracy and reliability is iteratively improved over time without resource consuming rules intensive processing. Machine learning processes can be performed for increased accuracy and for reduction of reliance on rules-based criteria and thus reduced computational overhead. For enhancement of computational accuracies, embodiments can feature computational platforms existing only in the realm of computer networks such as artificial intelligence platforms, and machine learning platforms. Embodiments herein can employ data structuring processes, e.g., processing for transforming unstructured data into a form optimized for computerized processing. Embodiments herein can examine data from diverse data sources such as data sources that process radio signals for location determination of users. Embodiments herein can include artificial intelligence processing platforms featuring improved processes to transform unstructured data into structured form permitting computer-based analytics and decision making. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (Saas), Platform-as-a-Service (PaaS), Database-as-a-Service (DBaaS), and combinations thereof based on types of subscription.

By leveraging data structures to organize relationships, the techniques described herein can increase efficiency in locating relevant content that can be extracted for presentment to interfaces described herein.

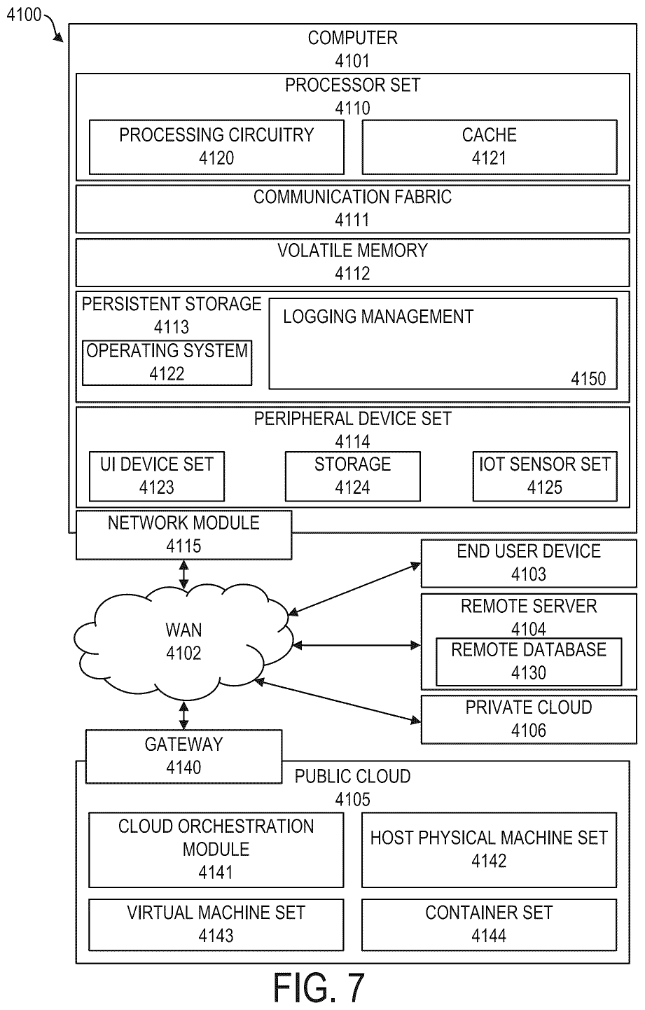

In reference to FIG. 7 there is set forth a description of a computing environment 4100 that can include one or more computer 4101. In one example, computing node 10 as set forth herein can be provided in accordance with computer 4101 as set forth in FIG. 7.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 7. In one aspect, a computing environment 4100 contains an example of an environment for the execution of at least some of the computer code involved in performing the inventive methods, such as code 4150 for performing logging management functions described with reference to FIGS. 1-6. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid-state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers. software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example. the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area. such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101) and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including. for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements but is not limited to possessing only those one or more steps or elements. Likewise, a step of a method or an element of a device that “comprises,” “has,” “includes,” or “contains” one or more features possesses those one or more features but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

1. A computer implemented method comprising:
generating log messages from one or more data source;
evaluating one or more log message produced from the generating, and outputting, in dependence on the evaluating the one or more log message, a log message rating of the one or more log message;
evaluating a logging system, and outputting, in dependence on the evaluating the logging system, a logging system rating of the logging system, wherein the logging system includes a logging volume for storing log messages;
comparing the log message rating to the logging system rating; and
producing an action decision impacting a count of log messages stored in the storage volume in dependence on the comparing of the log message rating, and the logging system rating.

2. The computer implemented method of claim 1, wherein the method includes performing the evaluating the one or more log message, the evaluating the logging system, the comparing and the producing an action decision impacting the count of log messages stored in the logging volume on ingestion of the one or more log message into the logging volume.

3. The computer implemented method of claim 1, wherein the method includes iteratively performing the evaluating the one or more log message, the evaluating the logging system, the comparing and the producing an action decision impacting the count of log messages stored in the logging volume subsequent to ingestion of the one or more log message into the logging volume.

4. The computer implemented method of claim 1, wherein the method includes performing the evaluating the one or more log message, the evaluating the logging system, the comparing and the producing an action decision impacting the count of log messages stored in the logging volume on ingestion of the one or more log message into the logging volume, and wherein the method includes iteratively performing the evaluating the one or more log message, the evaluating the logging system, the comparing and the producing an action decision impacting the count of log messages stored in the logging volume subsequent to ingestion of the one or more log message into the logging volume.

5. The computer implemented method of claim 1, wherein the evaluating the one or more log message produced from the generating, and outputting, in dependence on the evaluating the one or more log message, the log message rating of the one or more log message, includes evaluating multiple log message importance factors, wherein first and second ones of the multiple log message importance factors include differentiated factors selected from the group consisting of (a) a source factor in dependence on a data source generating the one or more log message, (b) an age factor in dependence on an age of the one or more log message, (c) a queries factor in dependence on a current rate at which the one or more log message is being queried, (d) a log level factor in dependence on an age of the one or more log message, (e) a redundancy factor in dependence on level of similarity of the one or more log message to a stored log message of the logging volume, (f) a size factor in dependence on a number of characters defining the one or more log message, and (g) a trend factor in dependence on a history of a rating assigned to the one or more log message over time.

6. The computer implemented method of claim 1, wherein the evaluating the logging system, and outputting, in dependence on the evaluating the logging system, the logging system rating of the logging system includes evaluating multiple logging system pressure factors, wherein first and second ones of the multiple logging system pressure factors include differentiated factors selected from the group consisting of (a) an ingestion rate factor in dependence on a current rate at which new log messages are being ingested into the logging volume, (b) a contentions factor in dependence on current rate of contentions recorded for the logging volume, (c) an availability factor in dependence on current computing resource availability for a computing node defining the logging volume, and (d) a trend factor in dependence on a history of ratings assigned to the logging system over time.

7. The computer implemented method of claim 1, wherein the evaluating the one or more log message produced from the generating, and outputting, in dependence on the evaluating the one or more log message, the log message rating of the one or more log message, includes evaluating multiple log message importance factors and condensing the multiple log message importance factors into the log message rating of the one or more log message.

8. The computer implemented method of claim 1, wherein the evaluating the logging system, and outputting, in dependence on the evaluating the logging system, the logging system rating of the logging system includes evaluating multiple logging system pressure factors and condensing the multiple logging system pressure factors into the logging system rating of the logging system.

9. The computer implemented method of claim 1, wherein the evaluating the one or more log message produced from the generating, and outputting, in dependence on the evaluating the one or more log message, the log message rating of the one or more log message, includes evaluating multiple log message importance factors and condensing the multiple log message importance factors into the log message rating of the one or more log message, wherein the evaluating the logging system, and outputting, in dependence on the evaluating the logging system, the logging system rating of the logging system includes evaluating multiple logging system pressure factors and condensing the multiple logging system pressure factors into the logging system rating of the logging system.

10. The computer implemented method of claim 1, wherein the evaluating the one or more log message produced from the generating, and outputting, in dependence on the evaluating the one or more log message, the log message rating of the one or more log message, includes evaluating multiple log message importance factors and condensing the multiple log message importance factors into the log message rating of the one or more log message, wherein the evaluating the logging system, and outputting, in dependence on the evaluating the logging system, the logging system rating of the logging system includes evaluating multiple logging system pressure factors and condensing the multiple logging system pressure factors into the logging system rating of the logging system, and wherein the method includes providing the logging system rating on a common numerical scale with the log message rating that facilitates the comparing the log message rating to the logging system rating.

11. The computer implemented method of claim 1, wherein the evaluating the one or more log message produced from the generating. and outputting, in dependence on the evaluating the one or more log message, the log message rating of the one or more log message, includes evaluating multiple log message importance factors and condensing the multiple log message importance factors into the log message rating of the one or more log message, wherein the evaluating the logging system, and outputting, in dependence on the evaluating the logging system, the logging system rating of the logging system includes evaluating multiple logging system pressure factors and condensing the multiple logging system pressure factors into the logging system rating of the logging system, and wherein the method includes providing the logging system rating on a common numerical scale with the log message rating that facilitates the comparing the log message rating to the logging system rating, wherein first and second ones of the multiple log message importance factors include differentiated factors selected from the group consisting of (a) a source factor in dependence on a data source generating the one or more log message, (b) an age factor in dependence on an age of the one or more log message, (c) a queries factor in dependence on a current rate at which the one or more log message is being queried, (d) a log level factor in dependence on an age of the one or more log message, (e) a redundancy factor in dependence on level of similarity of the one or more log message to a stored log message of the logging volume, and (f) a size factor in dependence on a number of characters defining the one or more log message, wherein first and second ones of the multiple logging system pressure factors include differentiated factors selected from the group consisting of (i) an ingestion rate factor in dependence on a current rate at which new log messages are being ingested into the logging volume, (ii) a contentions factor in dependence on current rate of contentions recorded for the logging volume, and (iii) an availability factor in dependence on current computing resource availability for a computing node defining the logging volume.

12. A system comprising:
a memory;
at least one processor in communication with the memory; and
program instructions executable by one or more processor via the memory to perform a method comprising:
generating log messages from one or more data source;
evaluating one or more log message produced from the generating, and outputting, in dependence on the evaluating the one or more log message, a log message rating of the one or more log message;
evaluating a logging system, and outputting, in dependence on the evaluating the logging system, a logging system rating of the logging system, wherein the logging system includes a logging volume for storing log messages;
comparing the log message rating to the logging system rating; and
producing an action decision impacting a count of log messages stored in the storage volume in dependence on the comparing of the log message rating, and the logging system rating.

13. (canceled)

14. (canceled)

15. (canceled)

16. The system of claim 12, wherein the evaluating the one or more log message produced from the generating, and outputting, in dependence on the evaluating the one or more log message, the log message rating of the one or more log message, includes evaluating multiple log message importance factors, wherein the multiple log message importance factors include each of (a) a source factor in dependence on a data source generating the one or more log message, (b) an age factor in dependence on an age of the one or more log message, (c) a queries factor in dependence on a current rate at which the one or more log message is being queried, (d) a log level factor in dependence on an age of the one or more log message, (e) a redundancy factor in dependence on level of similarity of the one or more log message to a stored log message of the logging volume, (f) a size factor in dependence on a number of characters defining the one or more log message, and (g) a trend factor in dependence on a history of a rating assigned to the one or more log message over time.

17. The system of claim 12, wherein the evaluating the logging system, and outputting, in dependence on the evaluating the logging system, the logging system rating of the logging system includes evaluating multiple logging system pressure factors, wherein the multiple logging system pressure factors include each of (a) an ingestion rate factor in dependence on a current rate at which new log messages are being ingested into the logging volume, (b) a contentions factor in dependence on current rate of contentions recorded for the logging volume, (c) an availability factor in dependence on current computing resource availability for a computing node defining the logging volume, and (d) a trend factor in dependence on a history of ratings assigned to the logging system over time.

18. The system of claim 12, wherein the evaluating the one or more log message produced from the generating, and outputting, in dependence on the evaluating the one or more log message, the log message rating of the one or more log message, includes evaluating multiple log message importance factors and condensing the multiple log message importance factors into the log message rating of the one or more log message, wherein the evaluating the logging system, and outputting, in dependence on the evaluating the logging system, the logging system rating of the logging system includes evaluating multiple logging system pressure factors and condensing the multiple logging system pressure factors into the logging system rating of the logging system.

19. The system of claim 12, wherein the evaluating the one or more log message produced from the generating, and outputting, in dependence on the evaluating the one or more log message, the log message rating of the one or more log message, includes evaluating multiple log message importance factors and condensing the multiple log message importance factors into the log message rating of the one or more log message, wherein the evaluating the logging system, and outputting, in dependence on the evaluating the logging system, the logging system rating of the logging system includes evaluating multiple logging system pressure factors and condensing the multiple logging system pressure factors into the logging system rating of the logging system, and wherein the method includes providing the logging system rating on a common numerical scale with the log message rating that facilitates the comparing the log message rating to the logging system rating, wherein the multiple log message importance factors include each of (a) a source factor in dependence on a data source generating the one or more log message, (b) an age factor in dependence on an age of the one or more log message, (c) a queries factor in dependence on a current rate at which the one or more log message is being queried, (d) a log level factor in dependence on an age of the one or more log message, (e) a redundancy factor in dependence on level of similarity of the one or more log message to a stored log message of the logging volume, and (f) a size factor in dependence on a number of characters defining the one or more log message, wherein the multiple logging system pressure factors include each of (i) an ingestion rate factor in dependence on a current rate at which new log messages are being ingested into the logging volume, (ii) a contentions factor in dependence on current rate of contentions recorded for the logging volume, and (iii) an availability factor in dependence on current computing resource availability for a computing node defining the logging volume.

20. A computer program product comprising:
a computer readable storage medium readable by one or more processing circuit and storing instructions for execution by one or more processor for performing a method comprising:
generating log messages from one or more data source;
executing programmed parsing and feature-extraction logic for evaluating one or more log message produced from the generating, and outputting, in dependence on the evaluating the one or more log message, a log message rating of the one or more log message that is stored in the system memory for automated use in further processing;
monitoring operating conditions of a logging system via computing resources, and evaluating a logging system, and outputting, in dependence on the evaluating the logging system, a logging system rating of the logging system, wherein the logging system includes a persistent logging volume defined in computer storage for storing log messages;
comparing the log message rating to the logging system rating using processor-implemented comparison logic; and
automatically controlling the logging system to initiate, without human intervention, an action impacting a count of log messages stored in the logging volume, the action comprising at least one of retaining. down-sampling, compressing, or deleting log messages in dependence on the comparing of the log message rating, and the logging system rating, wherein the action physically alters the data maintained in the persistent computer storage.

21. The computer-implemented method of claim 1, wherein generating log messages from one or more data sources includes processor-executed collection operations that obtain log data through ordinary system interfaces and place the log messages into a memory location accessible to the logging system.

22. The computer-implemented method of claim 1, wherein generating log messages from one or more data sources includes processor-executed collection operations that obtain log data through ordinary system interfaces and place the log messages into a memory location accessible to the logging system, wherein comparing the log-message rating to the logging-system rating further includes use of programmed comparison logic executed by a processor, the programmed logic being operable to adjust comparison sensitivity in view of current system resource conditions so that the comparison reflects ongoing operation of the logging system.

23. The computer-implemented method of claim 1, wherein generating log messages from one or more data sources includes processor-executed collection operations that obtain log data through ordinary system interfaces and place the log messages into a memory location accessible to the logging system, wherein comparing the log-message rating to the logging-system rating further includes use of programmed comparison logic executed by a processor, the programmed logic being operable to adjust comparison sensitivity in view of current system resource conditions so that the comparison reflects ongoing operation of the logging system, further comprising automatically directing the logging system to carry out one or more storage-related actions, without requiring human confirmation, the actions including retaining selected log messages, reducing a volume of log messages through down-sampling or compression, or removing redundant log messages, thereby modifying data that is maintained in persistent computer storage.
